(19) United States
(12) Patent Application Publication
(10) Pub. No.: US 2025/0265468 A1
(43) Pub. Date: Aug. 21, 2025

(54) Incident & Problem Management Data Accuracy Using Generative AI

(71) Applicant: Bank of America Corporation, Charlotte, NC (US)

(72) Inventors: Khandavally Shiva Ranga Prasad, Hyderabad (IN); Kishor Kumar Reddy Kalavagadda, Hyderabad (IN); Siddhendra Korrapati, Hyderabad (IN)

(21) Appl. No.: 18/442,804

(22) Filed: Feb. 15, 2024

(51) Int. Cl. G06N 3/0895; G06N 3/0475; G06N 5/04; G06N 7/01

(52) U.S. Cl. CPC G06N 3/0895; G06N 3/0475; G06N 5/04; G06N 7/01

(57) ABSTRACT

Computer-implemented methods and systems are disclosed for Information Technology Service Management (ITSM). The pioneering AI-driven system revolutionizes IT service management by uniquely validating, suggesting, and inferencing incident and problem data. At its core are cutting-edge generative AI techniques like GANs and LLMs, requiring intricate training and iterative refinement on varied data sets, showcasing a depth of expertise in database structures and AI concepts. It bridges critical gaps in incident resolution and classification through cognitive computing, AI, NLP, and deep learning, applied to both historical and current data. The system comprises modules for Incident Validation & Classification, Resolution Validation, Generative Intelligence, Problem Probability Calculation, and Prevention Recommendation, each employing AI to enhance standard compliance, predictive analysis, and proactive management, thereby setting new standards for IT service management efficiency and effectiveness.

### TECHNICAL FIELD

The present disclosure relates to data processing systems for artificial intelligence. This invention is designed to enhance Information Technology Service Management (ITSM) through the application of advanced AI techniques, including natural language processing (NLP) and machine learning (ML). It seeks to address and automate the standardization of incident and problem management processes, utilizing cognitive computing to ensure accurate classification and resolution documentation within IT systems. This system aims to improve the efficiency and accuracy of IT service management and knowledge databases, contributing to the stability and reliability of IT operations.

### DESCRIPTION OF THE RELATED ART

Information Technology Service Management (ITSM) plays a pivotal role in the operational integrity of an organization's IT infrastructure, encompassing incident management (IM) and problem management (PM). The crux of the problem lies in the lack of a standardized procedure for logging and resolving IT incidents. When incidents occur, they are documented and addressed manually, leading to a variety of approaches by different individuals. The subsequent documentation often omits crucial resolution steps and proper categorization of the incident's root cause. The absence of uniformity in documenting incidents results in a flawed knowledge management system, where inaccuracies in the worklogs and the resolution process can lead to misleading metrics. This hampers an organization's ability to assess and improve its ITSM efficiency accurately. Furthermore, to ensure quality, many organizations implement a secondary review of incident resolutions, a process that becomes increasingly cumbersome with the volume of incidents a large organization faces.

If the root cause is not accurately identified and classified, recurring incidents might not be investigated thoroughly, potentially leading to a compromised IT system. An unstable IT system can have far-reaching consequences, such as poor customer experience and risks to operational continuity and reputation.

Currently, there is no solution in the world that leverages artificial intelligence to validate, suggest modifications for, and generate valuable inferences from incident and problem management data. This underscores a significant gap in ITSM, where AI's potential to enhance data accuracy and utility remains untapped, indicating a need for innovation in this area.

Further, there is a lack of a universally applied standard for narrating the issue at hand and for recording the resolution once the incident is rectified. This can result in multiple tickets for the same issue, an ineffective Known Error Database (KEDB), and increased resolution times. There's a glaring gap in the market for a solution that can intelligently classify incident causes and guarantee that descriptions and resolutions adhere to predefined standards.

There is a clear demand for a sophisticated solution that utilizes cognitive computing, artificial intelligence, natural language processing, and deep learning to overcome these challenges. Such a system would not only automate the analysis and classification of incident causes but also streamline the initiation of problem investigation tickets. This innovation could significantly enhance the ITSM process, ensuring stability and efficiency in IT operations.

### SUMMARY OF THE INVENTION

In accordance with one or more arrangements of the non-limiting sample disclosures contained herein, solutions are provided to address one or more of the above issues and problems by, inter alia, using sophisticated ITSM systems and methods to automate and standardize the processes of incident and problem management within IT systems. It leverages cognitive computing, AI, NLP, and deep learning to ensure precise classification and documentation of IT incidents. This system aims to resolve the current inefficiencies in Knowledge Management and metrics by providing a standardized approach to incident logging. It's also geared toward alleviating the workload on quality assurance processes in large organizations by reducing the volume of incidents through accurate root cause identification. This innovative system addresses the lack of standardized incident description and resolution, which often leads to the creation of redundant tickets and an ineffective Known Error Database (KEDB). The goal of the invention is to enhance the stability of IT systems, thereby improving customer experience and safeguarding the organization's reputation. The technical solutions disclosed herein integrate several cutting-edge technologies to revolutionize how ITSM processes are managed, particularly in the domains of incident resolution and problem management. By employing cognitive computing, AI, NLP, and deep learning algorithms, this system analyzes both historical and real-time data, ensuring incidents are accurately documented, classified, and resolved according to stringent standards. GANs and LLMs are instrumental in refining text data, verifying the accuracy of incident descriptions, and resolution steps against a vast corpus of historical incident data. This iterative training and validation process not only enhances the accuracy of incident and problem classification but also ensures the initiation of problem management processes is both timely and precise. This comprehensive approach significantly improves ITSM efficiency, reduces operational risks, and elevates the overall quality of IT support services.

Systems and methods may utilize one or more of the following modules to implement the ITSM solutions disclosed herein:

The Incident Validation & Classification Module leverages NLP technology to examine and regulate the phrasing in incident reports and resolutions, promoting uniformity and compliance with set standards. This process enhances the clarity and precision of documentation, ensuring all incident-related communications are consistent, easily understandable, and accurately reflect the incident's details and resolution efforts. This meticulous approach to documentation aids in streamlining incident management processes, improving knowledge sharing, and facilitating more effective incident analysis and resolution strategies.

The process is detailed and involves several steps to ensure the accuracy and completeness of incident documentation. Initially, the Incident Data Mining module extracts text from all relevant fields of an incident ticket, organizing this data in a logical order for further processing. Subsequently, the Extract Key Incident Features module identifies essential details extracted previously, preparing this information for an API call to the Cognitive Intelligence Module (CIM). This call includes ticket categorization among other critical data. Once the data is sent to CIM, it undergoes validation where a score is assigned to the incident based on predefined criteria. If the incident meets the required validation score, it is authorized for further action. However, if the score is not satisfactory, the system generates recommendations for additional modifications to improve the incident's documentation, particularly focusing on enhancing the precision and detail of the incident description, such as error messages and failure types. This multistep approach ensures that incident tickets are thoroughly analyzed and categorized, facilitating efficient resolution and contributing to improved IT service management practices.

The Incident Resolution Validation Module, leveraging cognitive AI, scrutinizes each step recorded in the incident resolution process for its completeness and accuracy. This module ensures that all actions taken to resolve an incident are not only documented fully but also align with the best practices and standards established for incident management. By automating this validation process, the module aids in maintaining a high quality of incident resolution documentation, facilitating easier review, knowledge sharing, and future reference, thus contributing to the overall improvement of IT service management processes.

This module encompasses a comprehensive approach to ensuring the thoroughness and accuracy of incident resolution documentation. Initially, it extracts relevant text from incident reports, organizing this data in a structured manner. The module then identifies critical details regarding the resolution, preparing this information for an assessment by the Cognitive Intelligence Module (CIM). This step involves evaluating the complexity and completeness of the resolution documentation against predefined standards. A high validation score from CIM indicates that the resolution meets the necessary standards, while a low score triggers a request for more detailed information, emphasizing the importance of providing a comprehensive step-by-step account of the resolution process. This ensures that each incident resolution is documented with enough detail to be useful for future reference and contributes to improving the overall IT service management system.

The Incident Generative AI Inference Module (GAIM) stands as the central component of this solution, utilizing Large Language Models (LLMs) to analyze text data from incidents. It generates insights through advanced processing, continually refining these insights to ensure they are accurate and relevant. This ongoing refinement process enables the system to adapt and improve over time, ensuring that the intelligence it provides is both current and highly applicable to enhancing IT service management practices.

This intelligence and inference module intricately handles IT service management data through several interconnected layers, starting from data extraction and cognitive AI application in the Data Layer. It progresses to the Data Classification & Blending Layer, where data undergoes blending, mining, and machine learning to establish critical thresholds. The Processing Layer leverages NLP and LLM to synthesize and refine insights. The Logical Inference Database employs hypothesis testing and cognitive AI for logical inference formation, continuously validating these inferences. The Rules Engine applies derived rules to ITSM data, informed by organizational policies and standards. Lastly, the Recommendation System integrates these insights, offering targeted recommendations to optimize incident and problem management processes.

The Problem Probability Calculation Module dynamically evaluates incidents related to specific items or applications, calculating a score that reflects the likelihood of these incidents escalating into more significant problems. This assessment helps prioritize issues that may require more immediate or intensive intervention, facilitating preemptive action to mitigate risks and improve system stability.

The modules within the Problem Probability Calculation Module work in tandem to enhance incident analysis and prevention strategies. The “Extract CI Information” module delves into the incident database to retrieve details about Configuration Items (CIs), error messages, and resolution steps, aiming to identify patterns that could indicate systemic issues. Following this, the “Call GAIM to get Problem Inferences” module leverages the Cognitive Intelligence Module (CIM) to analyze this data, extracting valuable inferences about potential problems. This detailed approach allows for a more nuanced understanding of incident trends and supports proactive measures in IT service management.

The Problem Prevention Recommendation Module delves into the underlying causes of incidents to provide targeted suggestions for improving processes. By analyzing the root causes, this module identifies weaknesses within the current ITSM framework and proposes actionable recommendations to prevent future incidents, enhancing overall system efficiency and reliability.

The Problem Prevention Recommendation Module processes root cause data of problems through data mining techniques. It then collaborates with the Inference Module to extract insights related to these root causes. By analyzing this data collectively, the module identifies if process gaps are the cause of problems. If so, it develops tailored recommendations to address these gaps, aiming to prevent the recurrence of similar problems in the future. This proactive approach enhances the overall effectiveness of IT service management by mitigating potential issues before they escalate.

Considering the foregoing, the following presents a simplified summary of the present disclosure to provide a basic understanding of various aspects of the disclosure. This summary is not limiting with respect to the exemplary aspects of the inventions described herein and is not an extensive overview of the disclosure. It is not intended to identify key or critical elements of or steps in the disclosure or to delineate the scope of the disclosure. Instead, as would be understood by a personal of ordinary skill in the art, the following summary merely presents some concepts of the disclosure in a simplified form as a prelude to the more detailed description provided below. Moreover, sufficient written descriptions of the inventions are disclosed in the specification throughout this application along with exemplary, non-exhaustive, and non-limiting manners and processes of making and using the inventions, in such full, clear, concise, and exact terms to enable skilled artisans to make and use the inventions without undue experimentation and sets forth the best mode contemplated for carrying out the inventions.

In some arrangements, a method utilizes a comprehensive computer-implemented approach for managing IT service incidents. It starts by receiving incident data, which is then processed for validation and classification using natural language processing. Insights and potential causes of the incident are generated using a Generative AI Inference Module. A probability score is calculated to assess the risk of escalation, while the effectiveness of resolution actions is validated against standards. Preventive actions are recommended based on these analyses, and a knowledge database is updated to improve future management processes.

In some arrangements, a computer-implemented approach is used for managing and mitigating IT service incidents. This method begins with a system, which includes a processor and memory, receiving incident data. This data is then processed by an Incident Validation and Classification Module, which validates and categorizes the incident using advanced natural language processing techniques. It compares the data against historical incidents to analyze severity and urgency. Following this, a Generative AI Inference Module generates predictive insights on potential causes, impacts, and resolution strategies by synthesizing data from various sources. A Problem Probability Calculation Module calculates a score indicating the likelihood of the incident becoming a significant problem, taking into account several factors. The effectiveness and compliance of resolution actions are validated by an Incident Resolution Validation Module. Based on a detailed analysis, a Problem Prevention Recommendation Module advises on preventive actions to reduce future risks. Finally, the system updates a knowledge database with all gathered and processed information, continuously refining the IT service incident and problem management process.

In some arrangements, the method can include additional features to enhance incident management. It starts by prioritizing incidents based on severity and urgency, which guides the system's response prioritization. The Generative AI Inference Module then tailors its predictive insights to these priorities, ensuring high-priority incidents receive focused attention. The Problem Probability Calculation Module dynamically updates its probability scores with real-time data, keeping assessments current. Feedback on preventive measures informs adjustments, creating a loop for continuous improvement. The Incident Resolution Validation Module automates compliance reporting, documenting the resolution process's effectiveness and adherence to standards. Notifications about incidents, their assessments, and recommendations are sent to stakeholders, improving organizational communication. Integration with external databases and tools enriches data analysis, enhancing the system's accuracy. A user interface allows manual review and adjustment of system outputs, ensuring flexibility for human judgment. The system secures incident data through advanced encryption, maintaining data integrity and confidentiality. It leverages machine learning to uncover new data patterns, enhancing predictive capabilities. Benchmarking against industry standards promotes continuous improvement, and the system updates classification criteria in response to evolving IT landscapes. Lastly, an analytics dashboard provides key metrics visualizations, supporting quick health and security assessments of IT services.

In some arrangements, a system for IT service incident management can comprise a processor and memory that store and execute instructions for various operations. It starts with receiving incident data, then uses an Incident Validation and Classification Module with natural language processing to classify incidents. A Generative AI Inference Module generates insights, while a Problem Probability Calculation Module assesses escalation risks. An Incident Resolution Validation Module evaluates resolution efforts, and a Problem Prevention Recommendation Module suggests preventive measures. The system updates a knowledge database with insights and recommendations to aid in incident management.

In some arrangements, building on the foundational system, enhanced configurations incorporate dynamic prioritization of incidents based on severity and urgency, optimizing resource allocation and response times for critical issues. The Generative AI Inference Module now integrates external data sources, like cybersecurity threat intelligence, improving insight accuracy. A feedback mechanism collects user evaluations on resolutions and recommendations, guiding the refinement of preventive measures. Additionally, a user interface offers real-time dashboards and analytics, supporting effective monitoring, management, and decision-making by administrators and IT staff.

In some arrangements, one or more various steps or processes disclosed herein can be implemented in whole or in part as computer-executable instructions (or as computer modules or in other computer constructs) stored on computer-readable media. Functionality and steps can be performed on a machine or distributed across a plurality of machines that are in communication with one another.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

FIG. 1 depicts a holistic view of managing ITSM processes through AI-driven modules in a functional, modular, flow diagram showing sample interactions, interfaces, steps, functions, and components in accordance with one or more aspects of this disclosure.

FIG. 2 depicts the Incident Validation & Classification Module in a functional, modular, flow diagram showing sample interactions, interfaces, steps, functions, and components in accordance with one or more aspects of this disclosure.

FIG. 3 depicts the Incident Resolution Validation Module in a functional, modular, flow diagram showing sample interactions, interfaces, steps, functions, and components in accordance with one or more aspects of this disclosure.

FIG. 4 depicts the Generative AI Inference Module (GAIM) in a functional, modular, flow diagram showing sample interactions, interfaces, steps, functions, and components in accordance with one or more aspects of this disclosure.

FIG. 5 depicts the Problem Probability Calculation Module in a functional, modular, flow diagram showing sample interactions, interfaces, steps, functions, and components in accordance with one or more aspects of this disclosure.

FIG. 6 depicts the Problem Prevention Recommendation Module in a functional, modular, flow diagram showing sample interactions, interfaces, steps, functions, and components in accordance with one or more aspects of this disclosure.

FIG. 7 depicts a sample process showing sample interactions, interfaces, steps, functions, and components in accordance with one or more aspects of this disclosure.

FIG. 8 depicts another sample process showing sample interactions, interfaces, steps, functions, and components in accordance with one or more aspects of this disclosure.

### DETAILED DESCRIPTION

The subsequent description of different embodiments aims to achieve the aforementioned goals, with reference to accompanying drawings that are integral to this document. These drawings illustrate several ways in which the disclosed information can be implemented. It should be recognized that alternative embodiments are possible, and modifications to structure and function can be made. This description mentions various connections between elements, which should be understood as broad and, unless otherwise indicated, can be direct or indirect, wired, or wireless. This specification is not meant to restrict these connections.

Throughout this document, the term “computers,” “machines,” or similar references are used interchangeably, depending on the context, to denote devices that may be general-purpose, customized, configured for specific purposes, virtual, physical, or capable of accessing networks. These include all associated hardware, software, and components as would be recognized by someone skilled in the field. Such devices might be equipped with one or more application-specific integrated circuits (ASICs), microprocessors, cores, or executors for running, accessing, controlling, or implementing various software, instructions, data, modules, processes, or routines as described herein. The references in this text are not to be seen as restrictive or exclusive to any particular type(s) of electronic device(s) or component(s) and should be understood in the broadest sense as per the knowledge of skilled individuals. Details on specific or general computer/software components, machines, etc., are omitted for conciseness and because they are assumed to be within the understanding of competent professionals in the field.

Software, computer-executable instructions, data, modules, processes, and similar elements can reside on physical storage media that is tangible and computer readable. This includes local memory, network-attached storage, and various forms of accessible memory whether removable, remote, cloud-based, or available through other means. Such elements can be stored in either volatile or non-volatile memory types and can operate in various modes such as autonomously, on-demand, on a schedule, spontaneously, proactively, or reactively. They may be stored collectively or dispersed across different computers or devices, encompassing their memory and additional components. Furthermore, these elements can also be stored or distributed across network-accessible storages, within distributed databases, big data environments, blockchains, or distributed ledger technologies, either in a similar fashion or via distributed means.

In this disclosure, the term “networks” or the like encompasses a variety of communication infrastructures, including local area networks (LANs), wide area networks (WANs), the Internet, cloud networks, both wired and wireless networks, digital subscriber line (DSL) networks, frame relay networks, asynchronous transfer mode (ATM) networks, and virtual private networks (VPN). These can be interconnected directly or indirectly. Networks may feature distinct interfaces tailored for internal, external, and management communications, with the option to assign virtual IP addresses (VIPs) to each as needed. The infrastructure of a network comprises various hardware and software components, including but not limited to access points, adapters, buses, ethernet adapters (both physical and wireless), firewalls, hubs, modems, routers, and switches. These components can be located within the network, at its edges, or externally. Additionally, software and computer-executable instructions operate on these components, facilitating network functions. Networks are capable of supporting HTTPS and various other communication protocols suitable for packet-based transmission and communication.

As used herein, Generative Artificial Intelligence (AI) or the like refers to AI techniques that learn from a representation of training data and use it to generate new content that is similar to or inspired by existing data. Generated content may include human-like outputs such as natural language text, source code, images/videos, and audio samples. Generative AI solutions typically leverage open-source or vendor sourced (proprietary) models, and can be provisioned in a variety of ways, including, but not limited to, Application Program Interfaces (APIs), websites, search engines, and chatbots. Most often, Generative AI solutions are powered by Large Language Models (LLMs) which were pre-trained on large datasets using deep learning with over 500 million parameters and reinforcement learning methods. Any usage of Generative AI and LLMs is preferably governed by an Enterprise AI Policy and an Enterprise Model Risk Policy.

Generative artificial intelligence models have been evolving rapidly, with various organizations developing their own versions. Sample generative AI models that can be used in accordance with various aspects of this disclosure include but are not limited to: (1) OpenAI GPT Models: (a) GPT-3: Known for its ability to generate human-like text, it's widely used in applications ranging from writing assistance to conversation. (b) GPT-4: An advanced version of the GPT series with improved language understanding and generation capabilities. (2) Meta (formerly Facebook) AI Models—Meta LLAMA (Language Model Meta AI): Designed to understand and generate human language, with a focus on diverse applications and efficiency. (3) Google AI Models: (a) BERT (Bidirectional Encoder Representations from Transformers): Primarily used for understanding the context of words in search queries. (b) T5 (Text-to-Text Transfer Transformer): A versatile model that converts all language problems into a text-to-text format. (4) DeepMind AI Models: (a) GPT-3.5: A model similar to GPT-3, but with further refinements and improvements. (b) AlphaFold: A specialized model for predicting protein structures, significant in the field of biology and medicine. (5) NVIDIA AI Models—Megatron: A large, powerful transformer model designed for natural language processing tasks. (6) IBM AI Models—Watson: Known for its application in various fields for processing and analyzing large amounts of natural language data. (7) XLNet: An extension of the Transformer model, outperforming BERT in several benchmarks. (8) GROVER: Designed for detecting and generating news articles, useful in understanding media-related content. These models represent a range of applications and capabilities in the field of generative AI. One or more of the foregoing may be used herein as desired. All are considered to be within the sphere and scope of this disclosure.

Generative AI and LLMs can be used in various aspects of this disclosure performing one or more various tasks, as desired, including: (1) Natural Language Processing (NLP): This involves understanding, interpreting, and generating human language. (2) Data Analysis and Insight Generation: Including trend analysis, pattern recognition, and generating predictions and forecasts based on historical data. (3) Information Retrieval and Storage: Efficiently managing and accessing large data sets. (4) Software Development Lifecycle: Encompassing programming, application development, deployment, along with code testing and debugging. (5) Real-Time Processing: Handling tasks that require immediate processing and response. (6) Context-Sensitive Translations and Analysis: Providing accurate translations and analyses that consider the context of the situation. (7) Complex Query Handling: Utilizing chatbots and other tools to respond to intricate queries. (8) Data Management: Processing, searching, retrieving, and utilizing large quantities of information effectively. (9) Data Classification: Categorizing and classifying data for better organization and analysis. (10) Feedback Learning: Processes whereby AI/LLMs improve performance based on feedback it receives. (Key aspects can include, for example, human feedback, Reinforcement Learning, interactive learning, iterative improvement, adaptation, etc.). (11) Context Determination: Identifying the relevant context in various scenarios. (12) Writing Assistance: Offering help in composing human-like text for various forms of writing. (13) Language Analysis: Analyzing language structures and semantics. (14) Comprehensive Search Capabilities: Performing detailed and extensive searches across vast data sets. (15) Question Answering: Providing accurate answers to user queries. (16) Sentiment Analysis: Analyzing and interpreting emotions or opinions from text. (17) Decision-Making Support: Providing insights that aid in making informed decisions. (18) Information Summarization: Condensing information into concise summaries. (19) Creative Content Generation: Producing original and imaginative content. (20) Language Translation: Converting text or speech from one language to another.

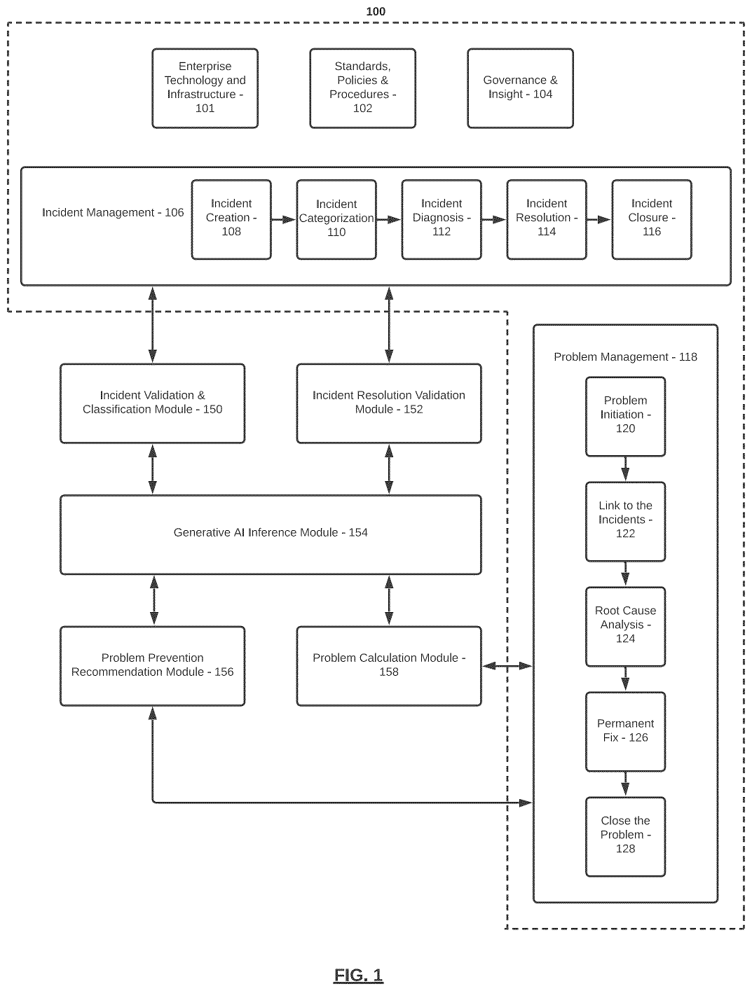

By way of non-limiting disclosure, FIG. 1 depicts a holistic view of managing ITSM processes through AI-driven modules in a functional, modular, flow diagram showing sample interactions, interfaces, steps, functions, and components in accordance with one or more aspects of this disclosure.

At a high level, FIG. 1 is a comprehensive IT Service Management (ITSM) framework, detailing the flow from enterprise technology infrastructure through to problem management. It starts with foundational elements such as standards, policies, and governance (reference numbers 100 to 104), proceeding through incident management phases like creation, categorization, diagnosis, resolution, and closure (reference numbers 106 to 116). The diagram further integrates specialized modules for incident validation and classification, resolution validation, and AI-driven inference (reference numbers 150 to 154), concluding with problem management steps from initiation to closure (reference numbers 118 to 128). This schematic representation encapsulates the holistic approach to managing IT incidents and problems, emphasizing the integration of AI and machine learning for enhanced decision-making and problem-solving.

Organizations likely already have components located with designation (100) in FIG. 1. Enterprise Technology and Infrastructure (101) refers to the physical and software components essential for an organization's IT operations. Standards, Policies, and Procedures (102) denote the rules and guidelines governing the use and management of IT resources. Governance and Insight (104) involves the oversight mechanisms and analyses used to ensure IT activities align with organizational goals, providing a structured framework for decision-making and strategic planning within ITSM processes.

Incident Management (106) encompasses several key stages: Incident Creation (108) is the initial logging of an issue. This progresses to Incident Categorization (110), where the incident is classified to aid in prioritization. Incident Diagnosis (112) involves investigating the cause, leading to Incident Resolution (114), where a fix is applied. The process concludes with Incident Closure (116), which confirms the resolution and documents the incident for future reference, ensuring a comprehensive approach to addressing IT issues.

Problem Management (118) involves a series of steps: starting with Problem Initiation (120), where issues are formally recognized and logged. This progresses to Problem Analysis (122) where link(s) to incident(s) are made and where the issues are deeply investigated to understand their root causes. Following analysis, Solution Development (124) is undertaken as part of a root cause analysis to devise and plan corrective actions. These solutions are then Implemented (126) to resolve the underlying problem as part of a permanent fix. The process concludes with Closing the Problem (128), ensuring the issue is fully resolved and documenting the outcome for future reference and learning.

The novel modules are able to interact with the foregoing as illustrated in the figure. The Incident Validation & Classification Module (150) and the Incident Resolution Validation Module (152) are communicatively coupled to Incident Management 106. The Incident Validation & Classification Module utilizes NLP to analyze and standardize incident descriptions and resolutions. The Incident Resolution Validation Module employs cognitive AI to verify the accuracy and completeness of resolution steps.

The Generative AI Inference Module (GAIM) (154) is a core aspect of the solutions provided herein and processes text data, from the Incident Validation & Classification Module (150) and the Incident Resolution Validation Module (152), using LLMs to generate insights, continuously refining its outputs.

The GAIM is also communicatively coupled to the Problem Prevention Recommendation Module (156) and the Problem Calculation Module (158). The Problem Probability Calculation Module assesses incidents for specific items or applications to score potential problem probabilities. The Problem Prevention Recommendation Module examines root causes to offer process improvement recommendations.

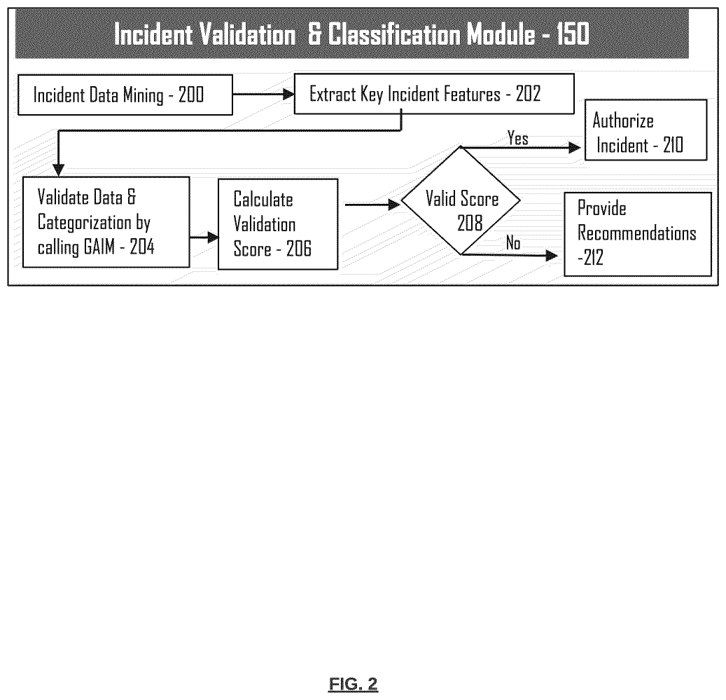

Additional details of each of these modules are illustrated in FIGS. 2-6, which respectively detail: the Incident Validation & Classification Module, the Incident Resolution Validation Module, the Generative AI Inference Module, the Problem Probability Calculation Module, and the Problem Prevention Recommendation Module. Together, these modules automate and improve IT incident management and problem resolution as described herein.

By way of non-limiting disclosure, FIG. 2 depicts the Incident Validation & Classification Module in a functional, modular, flow diagram showing sample interactions, interfaces, steps, functions, and components in accordance with one or more aspects of this disclosure.

The Incident Validation & Classification Module leverages natural language processing (NLP) to analyze incident descriptions and resolutions, ensuring they meet predefined standards. It involves extracting text, identifying key features, and using the Cognitive Intelligence Module (CIM) for validation. A satisfactory validation score authorizes the incident, while a low score triggers recommendations for additional details, focusing on improving incident documentation accuracy and detail.

FIG. 2 outlines the steps within the Incident Validation & Classification Module (150), showcasing the process from data extraction to authorization. It includes incident data mining (200), key feature extraction (202), and data validation and categorization (204) by calling the Generative AI Inference Module.

Incident Data Mining involves extracting and analyzing detailed information from incident reports. This process identifies patterns, trends, and root causes of incidents by sifting through vast amounts of data. It's a critical step in understanding and improving IT service management, enabling organizations to proactively address and mitigate recurring issues, enhance operational efficiency, and improve overall system stability. The text in all the relevant fields is extracted. Extracted text and data is processed in a logical order. Stated differently, this systematically extracts and organizes text from relevant incident fields. This structured approach ensures that all pertinent information is captured and prepared for further analysis, laying the groundwork for accurate incident classification and resolution.

The extraction of key incident features involves analyzing incident data to identify and isolate the most relevant information that can impact the incident's resolution and classification. This processes information gathered from incident data mining, identifying essential details like error messages, affected system components, and user impact. It then prepares an API call to the Cognitive Intelligence Module (CIM) with this categorized data and additional relevant information for further analysis and validation. Stated differently, this process may include pinpointing specific error messages, user impact, system components affected, and the context of the incident. Identifying these features helps in accurately categorizing incidents, prioritizing them based on severity and impact, and facilitating a more targeted and effective response to resolve the issues identified.

Data validation and categorization by the Generative AI Inference Module involves the AI analyzing incident data to assess its accuracy and relevance. The module uses machine learning and natural language processing to understand the context and content of the data, ensuring it aligns with predefined standards. Once validated, the AI categorizes the incident based on its characteristics, such as severity, type, and impacted IT services, facilitating targeted and efficient incident management and resolution processes.

A validation score is calculated in (206). If the score is determined to be valid in (208), then the incident is authorized in (210). Otherwise, recommendations are provided in (212). Stated differently, the CIM is called to validate the data. The Cognitive Intelligence Module (CIM) evaluates incident data against established criteria, assigning a validation score. A high score indicates compliance with standards, authorizing the incident for further action. Conversely, a low score triggers recommendations for enhancements, emphasizing the need for detailed incident descriptions, such as specific error messages and failure types, to ensure accurate classification and resolution.

This highlights the systematic approach to ensuring incident reports meet predefined standards. This figure effectively illustrates the workflow and methodologies employed to enhance the accuracy and consistency of incident management.

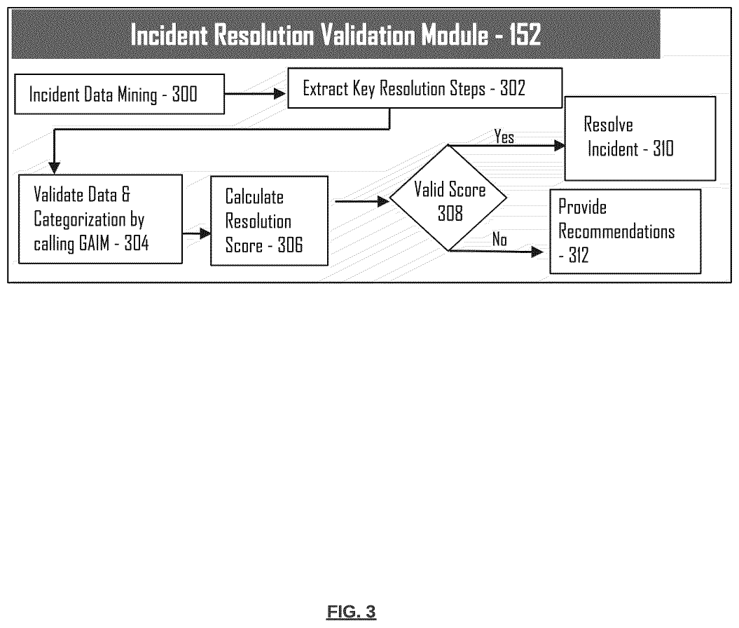

By way of non-limiting disclosure, FIG. 3 depicts the Incident Resolution Validation Module in a functional, modular, flow diagram showing sample interactions, interfaces, steps, functions, and components in accordance with one or more aspects of this disclosure.

The Incident Resolution Validation Module (152) uses cognitive AI to ensure incident resolution steps are accurately documented. It includes data mining for text extraction, key feature extraction for API calls to the Cognitive Intelligence Module (CIM), and validation through GAIM for a resolution complexity score. High scores indicate standard adherence, while low scores prompt requests for more detailed resolution descriptions, focusing on clarity and completeness of the documented steps.

The Incident Resolution Validation Module ensures that incident resolutions meet specific standards and classifications. It validates the completeness and accuracy of the resolution information provided. If the information is incomplete or invalid, it prompts users to make corrections. The module acts as a validator, ensuring that incidents are documented accurately and according to the right standards before they can be closed. This process includes using Generative AI to validate adherence to resolution standards, thereby enhancing data accuracy and compliance within the organization.

FIG. 3 illustrates the Incident Resolution Validation Module, detailing steps from incident data mining to providing recommendations. This module starts with mining incident data (300), identifying key resolution steps (302), and verifying these steps' alignment with standards via Generative AI Inference Module (GAIM). Based on GAIM's evaluation, it calculates a resolution score (306). If adjustments are needed, it offers specific recommendations (312) to ensure incident resolutions meet predefined quality standards, enhancing ITSM effectiveness.

Incident data mining 300 is performed the same as in FIG. 2. The extraction of key incident features is processing previously mined data to identify and isolate critical details related to the incident's resolution. It then compiles this information, along with resolution steps and other relevant data, into a format suitable for an API call to the Cognitive Intelligence Module (CIM). This process ensures that the incident resolution steps are thoroughly documented and prepared for validation, facilitating accurate and efficient analysis by the CIM.

The GAIM is called to validate the data. This involves contacting the Cognitive Intelligence Module (CIM) to assess the documented resolution steps against predefined standards. This assessment generates a “resolution complexness score,” indicating the adherence level to those standards. A high score suggests that the resolution documentation meets the required criteria, while a low score triggers a request for more detailed information. This module emphasizes ensuring the resolution steps are thoroughly and accurately described, enhancing the quality and reliability of incident management.

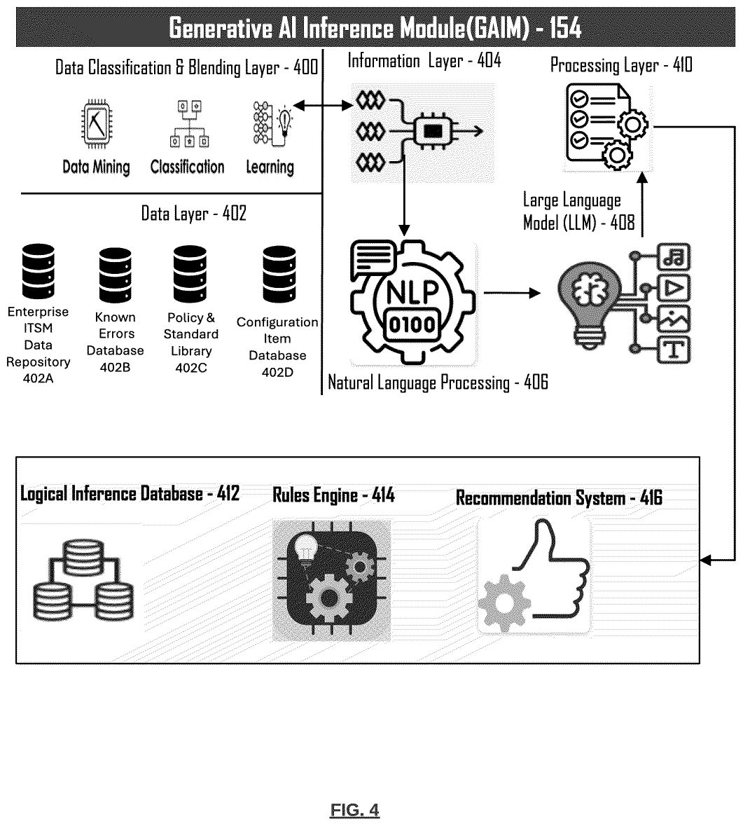

By way of non-limiting disclosure, FIG. 4 depicts the Generative AI Inference Module (GAIM) in a functional, modular, flow diagram showing sample interactions, interfaces, steps, functions, and components in accordance with one or more aspects of this disclosure.

FIG. 4 illustrates the Generative AI Inference Module (GAIM)—154, which includes several key components: the Data Classification & Blending Layer—400, the Information Layer—404, and the Processing Layer—410. It details the flow from the Data Layer—402, highlighting inputs from the Enterprise ITSM Data Repository—402A, Known Errors Database—402B, Policy & Standard Library—402C, and Configuration Item Database—402D. The diagram shows how data progresses through natural language processing (NLP)—405, to the Large Language Model (LLM)—408, and further to the Logical Inference Database—412, Rules Engine—414, and Recommendation System—416, demonstrating the sophisticated process of data handling and inference generation within the module.

The Data Classification & Blending Layer (400) serves as a component in the Generative AI Inference Module, focusing on merging and organizing data from various sources within an enterprise's ITSM environment. This layer applies advanced algorithms to blend data effectively, ensuring a unified dataset that is ready for deeper analysis. It also classifies the blended data, preparing it for subsequent processing and inference generation. This step is essential for extracting meaningful insights from complex and varied ITSM data, facilitating accurate problem identification and resolution. It includes the functionality of data mining, data classification, and learning. Moreover, the Data Classification & Blending Layer integrates and processes information from the Data Layer, applying techniques such as data blending and mining to organize and categorize the data effectively. It uses machine learning to evaluate and assign threshold scores to Configuration Items (CI), standards, policies, and known errors, facilitating a nuanced understanding and management of IT service data. This structured approach enhances the accuracy and utility of data in supporting IT service management and decision-making processes.

The Data Layer (402) forms the foundation of the Generative AI Inference Module, responsible for gathering and organizing data from diverse ITSM sources, including the Enterprise ITSM Data Repository, Known Error Database, Policy & Standard Library, and Configuration Item Database. This layer ensures that data from these varied sources is prepared and made available for further processing and analysis, setting the stage for advanced AI-driven insights. Stated differently, the Data Layer module aggregates and processes data from various ITSM sources, including the Enterprise IT Service Management Data Repository, Known Error Database, standards and policies, and Configuration Item Database. It employs cognitive AI technologies to analyze this comprehensive dataset, enabling the extraction of actionable insights and improving decision-making processes within IT service management frameworks.

The Information Layer (404) in the Generative AI Inference Module processes and enriches the data prepared by the previous layer. It utilizes advanced algorithms and techniques to analyze the data semantically. This layer aims to generate a comprehensive understanding of the data by identifying key concepts, relationships, and insights, which are crucial for creating accurate and meaningful inferences in subsequent processing stages.

The interaction between the Information Layer (404), Natural Language Processing (NLP) (406), and the Large Language Model (LLM) (408) involves a sophisticated data processing sequence. The Information Layer prepares and contextualizes the data, which is then analyzed by NLP to understand and interpret the language and semantics within the data. Following this, the LLM applies deep learning algorithms to generate insights and predictions based on the processed data, further refining the output for accuracy and relevance in ITSM applications.

The Processing Layer (410) takes the insights and predictions generated by the Large Language Model (LLM) (408) and applies further analysis to refine and validate these outputs. It uses advanced algorithms to process the LLM's output, integrating it with existing data models and frameworks to ensure the generated insights are actionable and aligned with ITSM objectives. This layer translates complex AI-generated data into practical solutions and recommendations for incident and problem management within IT systems. In other words, the Processing Layer takes the harmonized data from the previous stage and applies Natural Language Processing (NLP) to distill summaries and extract meaning from the text. This processed information is then advanced to a Large Language Model (LLM), which generates sophisticated inferences. The LLM operates through several iterations, each time refining and validating the results to ensure accuracy and relevance, thereby enhancing the decision-making process within IT service management through deep learning insights. The outputs from the Processing Layer (410) are intricately utilized across the Logical Inference Database (412), Rules Engine (414), and Recommendation System (416).

The Logical Inference Database integrates and analyzes data received from the Generative AI Inference Module (GAIM), conducting hypothesis testing to derive logical inferences with the help of cognitive AI technologies. These inferences are systematically stored in a database for further use. The module's accuracy and the relevance of its inferences undergo rigorous, iterative testing and refinement to ensure the highest levels of precision and applicability to ITSM processes. The Logical Inference Database stores and manages the refined insights for hypothesis testing and logical reasoning.

The Rules Engine processes and interprets data in accordance with established policies and standards, utilizing cognitive AI to formulate specific rules. These rules are then applied systematically to incident and problem data, ensuring that ITSM practices are aligned with organizational guidelines and best practices. This module plays a crucial role in automating and optimizing decision-making processes within IT service management, enhancing efficiency and compliance. The Rules Engine applies these insights to develop rules and guidelines, enhancing decision-making processes.

Lastly, the Recommendation System leverages both the rules and inferences to generate actionable recommendations, optimizing incident and problem management strategies within ITSM frameworks. In particular, the Recommendation System synthesizes insights from the Rules Engine and Logical Inference Database to generate actionable recommendations for managing incidents and problems. This integration ensures that suggestions are based on both the structured guidelines of the organization and the nuanced understandings derived from AI analysis, optimizing ITSM practices through informed decision-making.

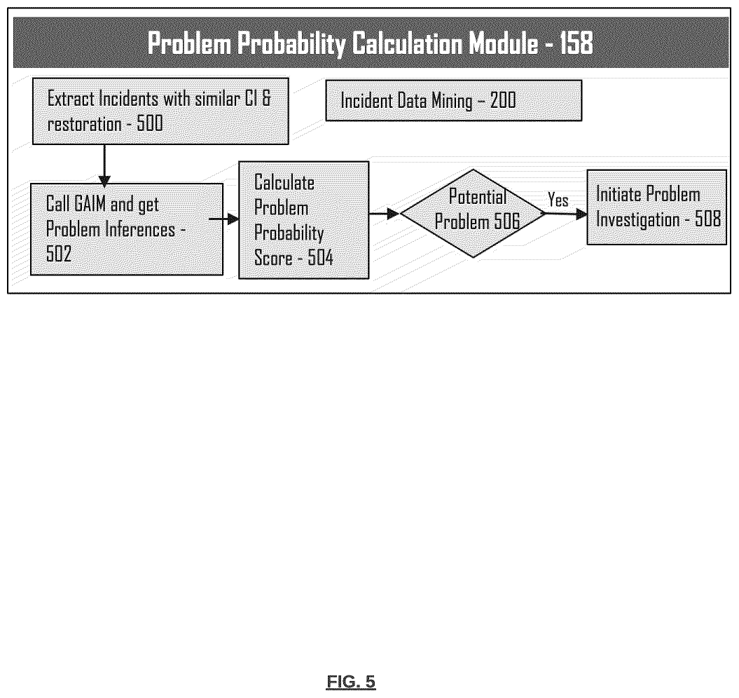

By way of non-limiting disclosure, FIG. 5 depicts the Problem Probability Calculation Module in a functional, modular, flow diagram showing sample interactions, interfaces, steps, functions, and components in accordance with one or more aspects of this disclosure.

The Problem Probability Calculation Module extracts information related to Configuration Items (CI) from each incident, looking for similarities in error messages and restoration methods. Subsequently, it communicates with the Cognitive Intelligence Module (CIM) to garner inferences about potential problems based on the extracted data. This dual-step process aids in assessing and quantifying the likelihood of recurring issues, facilitating preemptive measures in problem management.

FIG. 5 depicts the Problem Probability Calculation Module (158), detailing its workflow from extracting incidents with similar restoration efforts (500) through data mining (200), to calling the Generative AI Inference Module (GAIM) for problem inferences (502). It then calculates the Problem Probability Score (504) and, based on this score, decides whether to initiate a problem investigation (508). This figure illustrates a systematic approach to identifying and addressing potential recurring problems within IT systems, emphasizing the use of AI for predictive analysis.

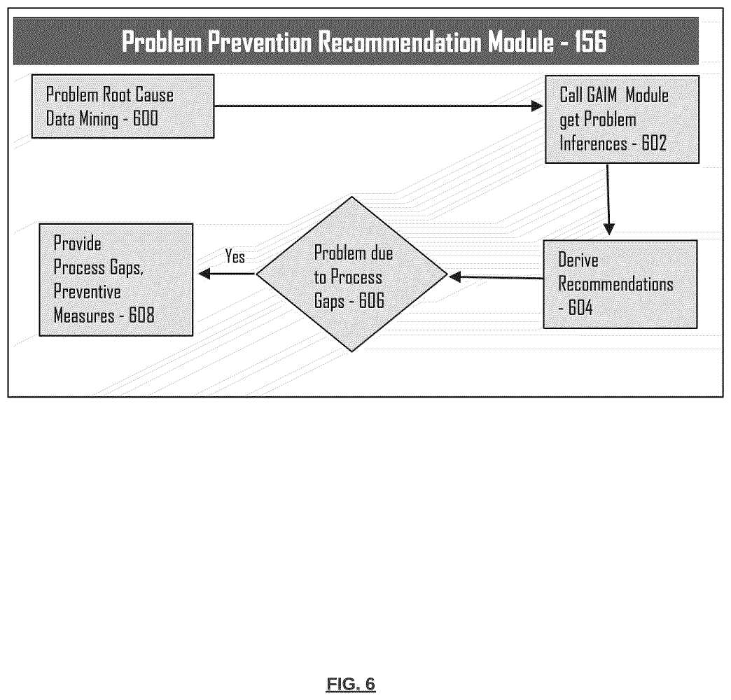

By way of non-limiting disclosure, FIG. 6 depicts the Problem Prevention Recommendation Module in a functional, modular, flow diagram showing sample interactions, interfaces, steps, functions, and components in accordance with one or more aspects of this disclosure.

FIG. 6 illustrates the Problem Prevention Recommendation Module (156), detailing its process from data mining of problem root causes (600) to generating preventive measures and recommendations (608). It starts with identifying root causes, then utilizes the Generative AI Inference Module (GAIM) to derive insights (602), leading to the identification of process gaps. Based on this analysis, it formulates recommendations (604) to address these gaps, aiming to prevent the recurrence of similar problems. This module emphasizes a proactive approach to ITSM by using AI to enhance problem management strategies. Stated differently, the module (156) conducts data mining on root cause data of problems, then utilizes an Inference Module to extract relevant inferences. It evaluates this data collectively to identify if process gaps contribute to the problems. Upon confirming process gaps, it devises recommendations aimed at addressing these deficiencies to prevent the recurrence of similar issues, thereby enhancing the efficacy of problem management within IT systems.

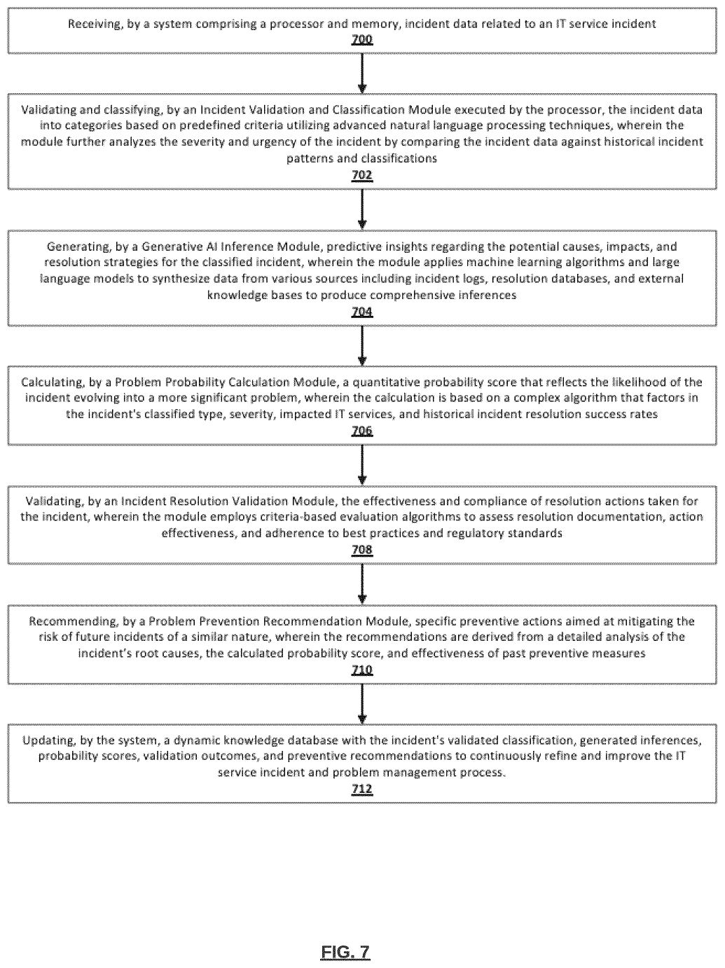

By way of non-limiting example, FIG. 7 depicts a sample process showing sample interactions, interfaces, steps, functions, and components in accordance with one or more aspects of this disclosure.

FIG. 7 outlines a system for managing IT service incidents, detailing a process that includes receiving and analyzing incident data, generating predictive insights, calculating the likelihood of incidents becoming significant problems, validating resolution actions, recommending preventive measures, and updating a knowledge database. The process leverages modules for incident validation and classification, AI inference, problem probability calculation, resolution validation, and prevention recommendations, aiming to refine and improve IT service incident and problem management continuously.

In 700, incident data related to an IT service incident is received by a system comprising a processor and memory. Next, an Incident Validation and Classification Module executed by the processor validates and classifies the incident data into categories based on predefined criteria utilizing advanced natural language processing techniques, wherein the module further analyzes the severity and urgency of the incident by comparing the incident data against historical incident patterns and classifications in 702.

Predictive insights regarding the potential causes, impacts, and resolution strategies for the classified incident are generated by a Generative AI Inference Module in 704, wherein the module applies machine learning algorithms and large language models to synthesize data from various sources including incident logs, resolution databases, and external knowledge bases to produce comprehensive inferences.

In 706, a Problem Probability Calculation Module calculates a quantitative probability score that reflects the likelihood of the incident evolving into a more significant problem, wherein the calculation is based on an algorithm that factors in one or more of the incident's classified type, severity, impacted IT services, and historical incident resolution success rates.

In 708, an Incident Resolution Validation Module validates the effectiveness and compliance of resolution actions taken for the incident, wherein the module employs criteria-based evaluation algorithms to assess resolution documentation, action effectiveness, and/or adherence to best practices and regulatory standards.

In 710, a Problem Prevention Recommendation Module recommends specific preventive actions aimed at mitigating the risk of future incidents of a similar nature, wherein the recommendations are derived from a detailed analysis of the incident's root causes, the calculated probability score, and effectiveness of past preventive measures.

Last, in 712, the system updates a dynamic knowledge database with the incident's validated classification, generated inferences, probability scores, validation outcomes, and/or preventive recommendations to continuously refine and improve the IT service incident and problem management process.

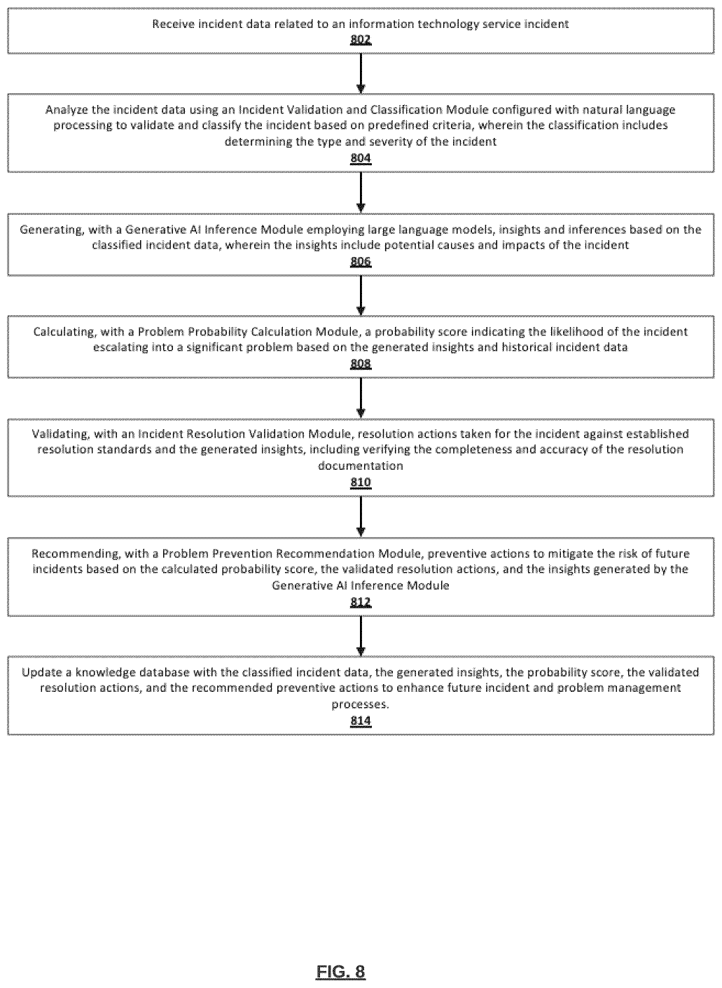

By way of non-limiting example, FIG. 8 depicts another sample process showing sample interactions, interfaces, steps, functions, and components in accordance with one or more aspects of this disclosure.

FIG. 8 provides a comprehensive overview of an IT service incident management process. Initially, it involves the collection of incident data, which is then subjected to an analytical phase for validation and classification. This phase utilizes natural language processing to ensure accurate incident categorization. Subsequently, a Generative AI Inference Module processes this data to generate insights concerning the incident's causes and potential impacts. Based on these insights, a Problem Probability Calculation Module evaluates the likelihood of incident escalation. The workflow proceeds with the validation of resolution measures, ensuring they meet predefined standards. Preventive actions are then recommended, aiming to mitigate future incidents. Finally, the entire process culminates in the updating of a knowledge database, which incorporates all generated insights, action validations, and recommendations. This database serves as a vital resource for enhancing future incident management strategies.

Incident data related to an information technology service incident is received in 802.

The incident data is analyzed, in 804, using an Incident Validation and Classification Module configured with natural language processing to validate and classify the incident based on predefined criteria, wherein the classification includes determining the type and severity of the incident.

A Generative AI Inference Module employing large language models generates insights and inferences based on the classified incident data in 806, wherein the insights include potential causes and impacts of the incident.

In 808, a Problem Probability Calculation Module calculates a probability score indicating the likelihood of the incident escalating into a significant problem based on the generated insights and historical incident data.

An Incident Resolution Validation Module validates, in 810, resolution actions taken for the incident against established resolution standards and the generated insights, including verifying the completeness and accuracy of the resolution documentation.

In 812, a Problem Prevention Recommendation Module recommends preventive actions to mitigate the risk of future incidents based on the calculated probability score, the validated resolution actions, and the insights generated by the Generative AI Inference Module.

Last, in 814, a knowledge database is updated with the classified incident data, the generated insights, the probability score, the validated resolution actions, and/or the recommended preventive actions to enhance future incident and problem management processes.

Thus, as the foregoing descriptions and examples demonstrate, the above solutions successfully leverage advanced artificial intelligence to address issues in IT service management, focusing on the accurate validation and categorization of incident data. By utilizing generative adversarial networks and large language models, the system is designed to process extensive datasets, ensuring that incident documentation meets established standards. This AI-driven approach not only facilitates the precise identification and resolution of IT incidents but also enhances the overall quality of IT service management by predicting and preventing future problems, thereby significantly improving operational efficiency and system reliability.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A computer-implemented method for managing and mitigating information technology (IT) service incidents, the method comprising the steps of:
receiving, by a system comprising a processor and memory, incident data related to an IT service incident;
validating and classifying, by an Incident Validation and Classification Module (IVCM) executed by the processor, the incident data into categories based on predefined criteria utilizing advanced natural language processing (NLP) techniques, wherein the IVCM further analyzes severity and urgency of the IT service incident by comparing the incident data against historical incident patterns and historical classifications;
generating, by a Generative AI Inference Module (GAIM), predictive insights regarding potential causes, impacts, and resolution strategies for the IT service incident as classified, wherein the GAIM applies machine learning (ML) algorithms and large language models (LLMs) to synthesize data from various sources including incident logs, resolution databases, and external knowledge bases to produce comprehensive inferences;
calculating, by a Problem Probability Calculation Module, a quantitative probability score that reflects a likelihood of the incident evolving into a more significant problem, wherein the calculation is based on an incident classification type, severity, impacted IT services, and historical incident resolution success rates;
validating, by an Incident Resolution Validation Module (IRVM), effectiveness and compliance of resolution actions taken for the incident, wherein the IRVM employs criteria-based evaluation algorithms to assess resolution documentation, action effectiveness, and adherence to best practices and regulatory standards;
recommending, by a Problem Prevention Recommendation Module, recommended preventive actions aimed at mitigating risk of future incidents of a similar nature, wherein the recommended preventive actions are derived from an analysis of root causes of the IT service incident, the quantitative probability score, and effectiveness of past preventive measures; and
updating, by the system, a dynamic knowledge database with a validated classification for the IT service incident, generated inferences, probability scores, validation outcomes, and preventive recommendations to continuously refine and improve the IT service incident and problem management process.

2. The method of claim 1, further comprising prioritizing the incident data based on severity and urgency classifications determined by the IVCM, wherein prioritization influences an order in which incidents are addressed by the system.

3. The method of claim 2, wherein the GAIM further customizes the predictive insights based on the prioritization, employing machine learning models tailored to handle high-priority incidents with enhanced urgency and accuracy.

4. The method of claim 3, wherein the Problem Probability Calculation Module incorporates real-time data analytics to dynamically adjust the quantitative probability score as new incident data is received, ensuring the quantitative probability score reflects most current information and trends.

5. The method of claim 4, further comprising adjusting the recommended preventive actions by the Problem Prevention Recommendation Module based on feedback received from implementation of previous recommendations, thereby creating a feedback loop that continuously refines the effectiveness of the preventive measures.

6. The method of claim 5, wherein the IRVM includes a component for automatic generation of compliance reports that document a resolution process, effectiveness of actions taken, and any deviations from established resolution standards.

7. The method of claim 6, further comprising a step where the system sends notifications to relevant stakeholders, including a summary of the IT service incident, the quantitative probability score, and the recommended preventive actions.

8. The method of claim 7, wherein the system integrates with external databases and incident management tools to enrich incident data analysis, leveraging external sources of information to enhance accuracy of the classification, the inference generation, and the quantitative probability score.

9. The method of claim 8, further comprising a user interface module that allows users to manually review and adjust the classifications, probability scores, and recommendations generated by the system, ensuring that human judgment can be applied for supervision.

10. The method of claim 9, wherein the system employs advanced encryption and security measures to protect integrity and confidentiality of the incident data, ensuring that data processing and communications are secure from unauthorized access.

11. The method of claim 10, further comprising utilizing machine learning algorithms within the GAIM to identify patterns and correlations in the incident data that were previously unrecognized, thereby enhancing predictive capabilities of the system over time through continuous learning.

12. The method of claim 11, including a benchmarking step where the system compares the effectiveness of the incident resolution and preventive measures against industry standards and metrics, facilitating ongoing improvement and adherence to best practices.

13. The method of claim 12, wherein the IVCM is further configured to automatically update classification criteria based on evolving IT service landscapes and emerging threat vectors, ensuring that the module remains effective in identifying and categorizing incidents.

14. The method of claim 13, wherein the system incorporates an analytics dashboard that provides visualizations of key metrics including incident frequency, resolution times, effectiveness of preventive actions, and trends in the probability scores.

15. A system for managing and mitigating information technology (IT) service incidents, comprising: a processor and a memory storing instructions that, when executed by the processor, enable the system to perform operations including: receiving incident data; utilizing an Incident Validation and Classification Module with natural language processing capabilities to validate and classify incidents; employing a Generative AI Inference Module that leverages large language models for generating insights; using a Problem Probability Calculation Module to compute incident escalation likelihood; implementing an Incident Resolution Validation Module for resolution effectiveness assessment; engaging a Problem Prevention Recommendation Module for actionable preventive measures; and updating a knowledge database with incident insights and recommendations.

16. The system of claim 15, further configured to prioritize incident handling based on severity and urgency determined by the Incident Validation and Classification Module, wherein a prioritization algorithm dynamically adjusts resource allocation and response times to ensure critical incidents are addressed promptly.

17. The system of claim 16, wherein the Generative AI Inference Module integrates external data sources, including cybersecurity threat intelligence feeds and IT service management logs, to enrich predictive insights with context-specific information, enhancing accuracy and relevance of the generated inferences.

18. The system of claim 17, further comprising a feedback mechanism that captures user feedback on resolution outcomes and preventive recommendations, wherein the feedback is utilized by the Problem Prevention Recommendation Module to refine and personalize future preventive actions, ensuring continuous improvement in incident prevention strategies.

19. The system of claim 18, equipped with a user interface that provides administrators and IT personnel with real-time dashboards, incident reports, and actionable analytics, enabling efficient monitoring, management, and decision-making based on the insights generated.

20. A computer-implemented method for managing information technology service incidents and problems comprising:
receiving incident data related to an information technology service incident;
analyzing the incident data using an Incident Validation and Classification Module configured with natural language processing to validate and classify the incident based on predefined criteria, wherein the classification includes determining a type and severity of the incident;
generating, with a Generative AI Inference Module employing large language models, insights and inferences based on the classified incident data, wherein the insights include potential causes and impacts of the incident;
calculating, with a Problem Probability Calculation Module, a probability score indicating the likelihood of the incident escalating into a significant problem based on the generated insights and historical incident data;
validating, with an Incident Resolution Validation Module, resolution actions taken for the incident against established resolution standards and the generated insights, including verifying completeness and accuracy of resolution documentation;
recommending, with a Problem Prevention Recommendation Module, preventive actions to mitigate the risk of future incidents based on the calculated probability score, the validated resolution actions, and the insights generated by the Generative AI Inference Module; and
updating a knowledge database with the classified incident data, the generated insights, the probability score, the validated resolution actions, and the recommended preventive actions to enhance future incident and problem management processes.
